(19) United States
(12) Patent Application Publication
(10) Pub. No.: US 2018/0206248 A1
(43) Pub. Date: Jul. 19, 2018

(54) RADIO RESOURCE CONTROL RRC CONNECTION RELEASING METHOD AND APPARATUS

(71) Applicant: HUAWEI TECHNOLOGIES CO., LTD., Shenzhen (CN)

(72) Inventors: Hongping ZHANG, Shanghai (CN); Le YAN, Shanghai (CN); Mingzeng DAI, Shanghai (CN); Qinghai ZENG, Shanghai (CN); Jing LIU, Shanghai (CN)

(21) Appl. No.: 15/919,237

(22) Filed: Mar. 13, 2018

Related U.S. Application Data
(63) Continuation of application No. PCT/CN2015/089708, filed on Sep. 16, 2015.

(51) Int. Cl. H04W 72/08; H04W 36/26; H04W 72/04; H04W 88/12

(52) U.S. Cl. CPC H04W 72/085; H04W 88/12; H04W 72/042; H04W 36/26

(57) ABSTRACT

Embodiments of the present invention provide an RRC connection method and an apparatus. The method includes: receiving, by a terminal, a deactivation indication message sent by a first base station, where the deactivation indication message carries indication information relating to mobility control of the terminal, and the first base station is a serving base station of the terminal; and releasing, by the terminal, an RRC connection according to the deactivation indication message, reserving context information of the terminal, and entering an inactive state. In this solution, the context information of the terminal does not need to be released, so that when entering a connected state again, the terminal does not need to obtain the context information again, thereby reducing signaling overheads.

### CROSS-REFERENCE TO RELATED APPLICATIONS

This application is a continuation of International Application No. PCT/CN2015/089708, filed on Sep. 16, 2015, the disclosure of which is hereby incorporated by reference in its entirety.

### TECHNICAL FIELD

The present invention relates to the field of communications technologies, and in particular, to an RRC (Radio Resource Control, radio resource control) connection releasing method and an apparatus.

### BACKGROUND

UE (User Equipment, user equipment) has two RRC states at an air interface: an idle (IDLE) state and a connected (Connected) state. When needing to implement a service, the UE first establishes a connection to a network, switches from the idle state to the connected state, and then performs data transmission. After the data transmission is completed, if the UE in the connected state does not perform data transmission for a long time, the UE needs to disconnect from the network, and switches from the connected state to the idle state.

When downlink data arrives or uplink data arrives, the UE initiates establishment of a new RRC connection at a cell on which the UE currently camps, and switches from the idle state to the connected state. Switching from the idle state to the connected state generates relatively high signaling overheads. With a growing quantity of user equipments, the network is faced with a continuous increase of a service volume, and the continuous increase of the service volume causes a continuous increase of control signaling load generated by switching from the idle state to the connected state. Due to a continuous increase of control signaling, more radio resources are needed to transmit the control signaling. In addition, an affected network node also needs more processing resources to process these control signaling, and this may cause the network node to be overloaded. Therefore, it is crucial to reduce signaling overheads in a UE state switching process.

However, an RRC connection releasing method that can resolve a problem that the signaling overheads in the UE state switching process are relatively high is not currently provided.

### SUMMARY

Embodiments of the present invention provide an RRC connection releasing method and an apparatus, to overcome a disadvantage in the prior art that signaling overheads are relatively high when UE switches from an idle state to a connected state.

According to a first aspect, a radio resource control RRC connection releasing method is provided, including:
receiving, by a terminal, a deactivation indication message sent by a first base station, where the deactivation indication message carries indication information relating to mobility control of the terminal, and the first base station is a serving base station of the terminal; and
releasing, by the terminal, an RRC connection according to the deactivation indication message, reserving context information of the terminal, and entering an inactive state.

With reference to the first aspect, in a first possible implementation, before the receiving, by a terminal, a deactivation indication message sent by a first base station, the method further includes:
sending, by the terminal, a deactivation request message to the first base station, where the deactivation request message is used to request the first base station to deactivate the terminal.

With reference to the first aspect or the first possible implementation of the first aspect, in a second possible implementation, the indication information is used to instruct the terminal in the inactive state to give priority to, when performing cell reselection, a cell controlled by the first base station; and
after the entering, by the terminal, an inactive state, the method further includes:
during cell reselection of the terminal, when determining, according to the indication information, that a first target cell meeting a reselection condition exists in the cell controlled by the first base station, performing cell reselection to the first target cell.

With reference to the second possible implementation of the first aspect, in a third possible implementation, after the entering, by the terminal, an inactive state, the method further includes:
during cell reselection of the terminal, when determining, according to the indication information, that the first target cell meeting the reselection condition does not exist in the cell controlled by the first base station, performing cell reselection according to broadcast cell reselection priority information.

With reference to the first aspect or the first possible implementation of the first aspect, in a fourth possible implementation, the indication information indicates a cell or base station that is preferred when the terminal in the inactive state performs cell reselection; and
after the entering, by the terminal, an inactive state, the method further includes:
during cell reselection of the terminal, when determining, according to the indication information, that a second target cell meeting a reselection condition exists in the preferred cell or a cell controlled by the preferred base station, performing cell reselection to the second target cell.

With reference to the fourth possible implementation of the first aspect, in a fifth possible implementation, after the entering, by the terminal, an inactive state, the method further includes:
during cell reselection of the terminal, when determining, according to the indication information, that the second target cell meeting the reselection condition does not exist in the preferred cell or the cell controlled by the preferred base station, performing cell reselection according to broadcast cell reselection priority information.

With reference to the first aspect or the first possible implementation of the first aspect, in a sixth possible implementation, the indication information is used to instruct to notify, when the terminal performs reselection to a cell controlled by a second base station, the second base station that the terminal performs reselection to the cell controlled by the second base station; and
after the entering, by the terminal, an inactive state, the method further includes:
when performing cell reselection to the cell controlled by the second base station, notifying, by the terminal according to the indication information, the second base station that the terminal performs reselection to the cell controlled by the second base station.

With reference to the sixth possible implementation of the first aspect, in a seventh possible implementation, the notifying, by the terminal according to the indication information, the second base station that the terminal performs reselection to the cell controlled by the second base station includes:
notifying, by the terminal according to the indication information by using a random access process, the second base station that the terminal performs reselection to the cell controlled by the second base station.

With reference to the first aspect or the first possible implementation of the first aspect, in an eighth possible implementation, the indication information indicates that, after the terminal performs reselection to a cell controlled by a second base station, the terminal is allowed to initiate an activation process at the second base station; and
after the entering, by the terminal, an inactive state, the method further includes:
after the terminal performs cell reselection to the cell controlled by the second base station, when determining that a preset condition is met, sending, by the terminal, an activation request message to the second base station, where the activation request message carries source cell information and terminal identifier information identifying an identity of the terminal;
receiving, by the terminal, an activation message sent by the second base station, and recovering a context according to the activation message; and
sending, by the terminal, an activation complete message to the second base station, and entering a connected state.

With reference to the first aspect or the first possible implementation of the first aspect, in a ninth possible implementation, after the entering, by the terminal, an inactive state, the method further includes:
when the terminal determines that a preset condition is met, sending, by the terminal, an activation request message to the first base station, where the activation request message carries source cell information and terminal identifier information identifying an identity of the terminal;
receiving, by the terminal, an activation message sent by the first base station, and recovering a context according to the activation message; and
sending, by the terminal, an activation complete message to the source base station, and entering a connected state.

With reference to the eighth or ninth possible implementation of the first aspect, in a tenth possible implementation, that the terminal determines that a preset condition is met includes:
the terminal determines that a paging message is received; or
the terminal determines that uplink data arrives; or
the terminal needs to perform a tracking area update TAU.

With reference to the eighth to tenth possible implementations of the first aspect, in an eleventh possible implementation, the activation message carries a context update parameter; and
after the recovering, by the terminal, a context according to the activation message, the method further includes:
updating, by the terminal, the recovered context according to the context update parameter.

With reference to the eighth to eleventh possible implementations of the first aspect, in a twelfth possible implementation, after the receiving, by the terminal, an activation message sent by the first base station or the second base station, the method further includes:
deriving, by the terminal, a first key or a second key based on information about a cell that initiates activation and the context information reserved by the terminal; and
communicating, by the terminal, with the first base station based on the first key, or communicating with the second base station based on the second key.

With reference to the first aspect or the first to twelfth possible implementations of the first aspect, in a thirteenth possible implementation, the deactivation indication message further carries context validity period information of the terminal; and
after the receiving, by a terminal, a deactivation indication message, the method further includes:
starting, by the terminal, a context validity period timer, and if the context validity period timer times out, releasing the context information of the terminal.

According to a second aspect, a radio resource control RRC connection releasing method is provided, including:
determining, by a first base station, that a preset condition is met; and
after determining that the preset condition is met, sending, by the first base station, a deactivation indication message to a terminal, and reserving context information of the terminal, where the deactivation indication message carries indication information relating to mobility control of the terminal, and the first base station is a serving base station of the terminal.

With reference to the second aspect, in a first possible implementation, the determining, by a first base station, that a preset condition is met includes:
determining, by the first base station, that an inactivity timer times out; or
receiving, by the first base station, a deactivation request message sent by the terminal, where the deactivation request message is used to request the first base station to deactivate the terminal.

With reference to the second aspect or the first possible implementation of the second aspect, in a second possible implementation, the indication information is used to instruct the terminal in the inactive state to give priority to, when performing cell reselection, a cell controlled by the first base station; or
the indication information indicates a cell or base station that is preferred when the terminal in the inactive state performs cell reselection.

With reference to the second aspect or the first and second possible implementations of the second aspect, in a third possible implementation, the indication information is used to instruct to notify, when the terminal performs reselection to a cell controlled by a second base station, the second base station that the terminal performs reselection to the cell controlled by the second base station, and/or, the indication information indicates that, after the terminal performs reselection to the second base station, the terminal is allowed to initiate an activation process at the second base station; and
after the sending, by the first base station, a deactivation indication message to a terminal, the method further includes:
receiving, by the first base station, a context request sent by the second base station, where the context request carries source cell information, terminal identifier information identifying an identity of the terminal, and target cell information; and
sending, by the first base station, the reserved context information of the terminal to the second base station.

With reference to the third possible implementation of the second aspect, in a fourth possible implementation, after the receiving, by the first base station, a context request sent by the second base station, the method further includes:
generating, by the first base station, a first key based on the target cell information, and sending the first key to the second base station.

With reference to the third or fourth possible implementation of the second aspect, in a fifth possible implementation, after the sending, by the first base station, the context information of the terminal to the second base station, the method further includes:
receiving, by the first base station, a context information release message sent by an MME or the second base station, and releasing the reserved context information according to the context information release message.

With reference to the second aspect or the first possible implementation of the second aspect, in a sixth possible implementation, after the sending, by the first base station, a deactivation indication message to a terminal, the method further includes:
receiving, by the first base station, an activation request message sent by the terminal, where the activation request message carries source cell information and terminal identifier information identifying an identity of the terminal;
when determining, according to the source cell information, that a source cell is a cell of the first base station, obtaining, by the first base station, the context information of the terminal;
sending, by the first base station, an activation message to the terminal; and
receiving, by the first base station, an activation complete message sent by the terminal.

With reference to the sixth possible implementation of the second aspect, in a seventh possible implementation, the activation message carries a context update parameter.

With reference to the sixth or seventh possible implementation of the second aspect, in an eighth possible implementation, after the receiving, by the first base station, an activation request message sent by the terminal, the method further includes:
deriving, by the first base station, a second key based on cell identifier information of a cell at which activation is initiated, and the context information reserved by the terminal; and
communicating, by the first base station, with the terminal based on the second key.

With reference to the sixth to eighth possible implementations of the second aspect, in a ninth possible implementation, after the receiving, by the first base station, an activation complete message sent by the terminal, the method further includes:
sending, by the first base station, a notification message to a mobility management entity MME, to notify the MME that the terminal enters a connected state.

According to a third aspect, a radio resource control RRC connection releasing method is provided, including:
receiving, by a second base station, an activation request message sent by a terminal, where the activation request message carries source cell information and terminal identifier information identifying an identity of the terminal; or receiving a notification message used by the terminal to notify, by using a random access process, that the terminal performs reselection to a cell controlled by the second base station;
sending, by the second base station, a context request to a first base station according to the activation request message or the notification message, where the context request is used to request for context information of the terminal, and the context request carries source cell information and terminal identifier information identifying an identity of the terminal; and
receiving, by the second base station, the context information that is of the terminal and that is returned by the first base station according to the context request.

With reference to the third aspect, in a first possible implementation, where after the sending, by the second base station, a context request to a first base station according to the activation request message or the notification message, the method further includes:
receiving, by the second base station, a first key sent by the first base station; and
communicating, by the second base station, with the terminal according to the first key.

With reference to the third aspect or the first possible implementation of the third aspect, in a second possible implementation, after the receiving, by the second base station, the context information that is of the terminal and that is returned by the first base station according to the context request, the method further includes:
sending, by the second base station, a notification message to a mobility management entity MME, where the notification message is used to notify the MME of information indicating that the terminal is currently located at the second base station.

According to a fourth aspect, a radio resource control RRC connection releasing method is provided, including:
receiving, by a mobility management entity MME, a notification message sent by a second base station, where the notification message is used to notify the MME that a terminal is currently in an inactive state, and the terminal performs reselection to a cell controlled by the second base station; and
sending, by the MME, a paging message to the second base station according to the notification message.

With reference to the fourth aspect, in a first possible implementation, after the receiving, by an MME, a notification message sent by a second base station, the method further includes:
transferring, by the MME, a data link of an S1 interface of the terminal to the second base station; and
sending, by the MME, a context information release message of the terminal to a first base station.

According to a fifth aspect, a terminal is provided, including:
a receiving unit, configured to receive a deactivation indication message sent by a first base station, where the deactivation indication message carries indication information relating to mobility control of the terminal, and the first base station is a serving base station of the terminal; and
a processing unit, configured to: release an RRC connection according to the deactivation indication message received by the receiving unit, reserve context information of the terminal, and enter an inactive state.

With reference to the fifth aspect, in a first possible implementation, the terminal further includes a sending unit, configured to send a deactivation request message to the first base station, where the deactivation request message is used to request the first base station to deactivate the terminal.

With reference to the fifth aspect or the first possible implementation of the fifth aspect, in a second possible implementation, the indication information is used to instruct the terminal in the inactive state to give priority to, when performing cell reselection, a cell controlled by the first base station; and
the processing unit is further configured to: during cell reselection of the terminal, when determining, according to the indication information, that a first target cell meeting a reselection condition exists in the cell controlled by the first base station, perform cell reselection to the first target cell.

With reference to the second possible implementation of the fifth aspect, in a third possible implementation, the processing unit is further configured to: during cell reselection of the terminal, when determining, according to the indication information, that the first target cell meeting the reselection condition does not exist in the cell controlled by the first base station, perform cell reselection according to broadcast cell reselection priority information.

With reference to the fifth aspect or the first possible implementation of the fifth aspect, in a fourth possible implementation, the indication information indicates a cell or base station that is preferred when the terminal in the inactive state performs cell reselection; and
the processing unit is further configured to: during cell reselection of the terminal, when determining, according to the indication information, that a second target cell meeting a reselection condition exists in the preferred cell or a cell controlled by the preferred base station, perform cell reselection to the second target cell.

With reference to the fourth possible implementation of the fifth aspect, in a fifth possible implementation, the processing unit is further configured to: during cell reselection of the terminal, when determining, according to the indication information, that the second target cell meeting the reselection condition does not exist in the preferred cell or the cell controlled by the preferred base station, perform cell reselection according to broadcast cell reselection priority information.

With reference to the fifth aspect or the first possible implementation of the fifth aspect, in a sixth possible implementation, the indication information is used to instruct to notify, when the terminal performs reselection to a cell controlled by a second base station, the second base station that the terminal performs reselection to the cell controlled by the second base station; and
the terminal further includes a sending unit, configured to: when the terminal performs cell reselection to the cell controlled by the second base station, notify, according to the indication information, the second base station that the terminal performs reselection to the cell controlled by the second base station.

With reference to the sixth possible implementation of the fifth aspect, in a seventh possible implementation, that the sending unit notifies, according to the indication information, the second base station that the terminal performs reselection to the cell controlled by the second base station is specifically:
notifying, according to the indication information by using a random access process, the second base station that the terminal performs reselection to the cell controlled by the second base station.

With reference to the fifth aspect or the first possible implementation of the fifth aspect, in an eighth possible implementation, the indication information indicates that, after the terminal performs reselection to a cell controlled by a second base station, the terminal is allowed to initiate an activation process at the second base station;
the processing unit is further configured to determine that a preset condition is met;
the terminal further includes a sending unit, configured to: after the terminal performs cell reselection to the cell controlled by the second base station, when the processing unit determines that the preset condition is met, send an activation request message to the second base station, where the activation request message carries source cell information and terminal identifier information identifying an identity of the terminal;
the receiving unit is further configured to receive an activation message sent by the second base station;
the processing unit is further configured to recover a context according to the activation message; and
the sending unit is further configured to send an activation complete message to the second base station, and enter a connected state.

With reference to the fifth aspect or the first possible implementation of the fifth aspect, in a ninth possible implementation, the processing unit is further configured to determine that a preset condition is met;
the terminal further includes a sending unit, configured to: when the processing unit determines that the preset condition is met, send an activation request message to the first base station, where the activation request message carries source cell information and terminal identifier information identifying an identity of the terminal;
the receiving unit is further configured to receive an activation message sent by the first base station;
the processing unit is further configured to recover a context according to the activation message; and
the sending unit is further configured to send an activation complete message to the source base station, and enter a connected state.

With reference to the eighth or ninth possible implementation of the fifth aspect, in a tenth possible implementation, that the processing unit determines that a preset condition is met is specifically:
it is determined that a paging message is received; or
it is determined that uplink data arrives; or
a tracking area update TAU needs to be performed.

With reference to the eighth to tenth possible implementations of the fifth aspect, in an eleventh possible implementation, the activation message carries a context update parameter; and
the processing unit is further configured to update the recovered context according to the context update parameter.

With reference to the eighth to eleventh possible implementations of the fifth aspect, in a twelfth possible implementation, the processing unit is further configured to: derive a first key or a second key based on information about a cell that initiates activation and the context information reserved by the terminal; and communicate with the first base station based on the first key, or communicate with the second base station based on the second key.

With reference to the fifth aspect or the first to twelfth possible implementations of the fifth aspect, in a thirteenth possible implementation, the deactivation indication message further carries context validity period information of the terminal; and
the processing unit is further configured to: start a context validity period timer, and if the context validity period timer times out, release the context information of the terminal.

According to a sixth aspect, a first base station is provided, including:
a processing unit, configured to determine that a preset condition is met; and
a sending unit, configured to: after the processing unit determines that the preset condition is met, send a deactivation indication message to a terminal, and reserve context information of the terminal, where the deactivation indication message carries indication information relating to mobility control of the terminal, and the first base station is a serving base station of the terminal.

With reference to the sixth aspect, in a first possible implementation, the first base station further includes a receiving unit, configured to receive a deactivation request message sent by the terminal; and
that the processing unit determines that a preset condition is met is specifically:
determining that an inactivity timer times out; or
receiving, by the receiving unit, a deactivation request message sent by the terminal, where the deactivation request message is used to request the first base station to deactivate the terminal.

With reference to the sixth aspect or the first possible implementation of the sixth aspect, in a second possible implementation, the indication information is used to instruct the terminal in the inactive state to give priority to, when performing cell reselection, a cell controlled by the first base station; or
the indication information indicates a cell or base station that is preferred when the terminal in the inactive state performs cell reselection.

With reference to the sixth aspect or the first and second possible implementations of the sixth aspect, in a third possible implementation, the indication information is used to instruct to notify, when the terminal performs reselection to a cell controlled by a second base station, the second base station that the terminal performs reselection to the cell controlled by the second base station, and/or, the indication information indicates that, after the terminal performs reselection to the second base station, the terminal is allowed to initiate an activation process at the second base station;
the first base station further includes a receiving unit, configured to receive a context request sent by the second base station, where the context request carries source cell information, terminal identifier information identifying an identity of the terminal, and target cell information; and
the sending unit is further configured to send the reserved context information of the terminal to the second base station.

With reference to the third possible implementation of the sixth aspect, in a fourth possible implementation, the processing unit is further configured to generate a first key based on the target cell information; and
the sending unit is further configured to send the first key to the second base station.

With reference to the third or fourth possible implementation of the sixth aspect, in a fifth possible implementation, the first base station further includes a receiving unit, configured to receive a context information release message sent by an MME or the second base station; and
the processing unit is further configured to release the reserved context information according to the context information release message.

With reference to the sixth aspect or the first possible implementation of the sixth aspect, in a sixth possible implementation, the first base station further includes a receiving unit, configured to receive an activation request message sent by the terminal, where the activation request message carries source cell information and terminal identifier information identifying an identity of the terminal;
the processing unit is further configured to: when determining, according to the source cell information, that a source cell is a cell of the first base station, obtain the context information of the terminal;
the sending unit is further configured to send an activation message to the terminal; and
the receiving unit is further configured to receive an activation complete message sent by the terminal.

With reference to the sixth possible implementation of the sixth aspect, in a seventh possible implementation, the activation message carries a context update parameter.

With reference to the sixth or seventh possible implementation of the sixth aspect, in an eighth possible implementation, the processing unit is further configured to: derive a second key based on cell identifier information of a cell at which activation is initiated, and the context information reserved by the terminal; and communicate with the terminal based on the second key.

With reference to the sixth to eighth possible implementations of the sixth aspect, in a ninth possible implementation, the sending unit is further configured to send a notification message to a mobility management entity MME, to notify the MME that the terminal enters a connected state.

According to a seventh aspect, a second base station is provided, including:
a receiving unit, configured to receive an activation request message sent by a terminal, where the activation request message carries source cell information and terminal identifier information identifying an identity of the terminal; or receive a notification message used by the terminal to notify, by using a random access process, that the terminal performs reselection to a cell controlled by the second base station;
a sending unit, configured to send a context request to a first base station according to the activation request message or the notification message, where the context request is used to request for context information of the terminal, and the context request carries source cell information and terminal identifier information identifying an identity of the terminal; and
the receiving unit is further configured to receive the context information that is of the terminal and that is returned by the first base station according to the context request.

With reference to the seventh aspect, in a first possible implementation, the receiving unit is further configured to receive a first key sent by the first base station; and
the second base station further includes a processing unit, configured to communicate with the terminal according to the first key.

With reference to the seventh aspect or the first possible implementation of the seventh aspect, in a second possible implementation, the sending unit is further configured to send a notification message to a mobility management entity MME, where the notification message is used to notify the MME of information indicating that the terminal is currently located at the second base station.

According to an eighth aspect, a mobility management entity MME is provided, including:
a receiving unit, configured to receive a notification message sent by a second base station, where the notification message is used to notify the MME that a terminal is currently in an inactive state, and the terminal performs reselection to a cell controlled by the second base station; and
a sending unit, configured to send a paging message to the second base station according to the notification message.

With reference to the eighth aspect, in a first possible implementation, the MME further includes a processing unit, configured to: transfer a data link of an S1 interface of the terminal to the second base station; and send a context information release message of the terminal to a first base station.

Embodiments of the present invention provide a radio resource control RRC connection releasing method, including: receiving, by a terminal, a deactivation indication message sent by a first base station, where the deactivation indication message carries indication information relating to mobility control of the terminal, and the first base station is a serving base station of the terminal; and releasing, by the terminal, an RRC connection according to the deactivation indication message, reserving context information of the terminal, and entering an inactive state. In this solution, the context information of the terminal does not need to be released, so that when entering a connected state again, the terminal does not need to obtain the context information again, thereby reducing signaling overheads.

### BRIEF DESCRIPTION OF DRAWINGS

FIG. 1 is a flowchart of releasing an RRC connection according to an embodiment of the present invention;

FIG. 2 is another flowchart of releasing an RRC connection according to an embodiment of the present invention;

FIG. 3 is another flowchart of releasing an RRC connection according to an embodiment of the present invention;

FIG. 4 is another flowchart of releasing an RRC connection according to an embodiment of the present invention;

FIG. 5 is another embodiment of releasing an RRC connection according to an embodiment of the present invention;

FIG. 6 is another embodiment of releasing an RRC connection according to an embodiment of the present invention;

FIG. 7 is another embodiment of releasing an RRC connection according to an embodiment of the present invention;

FIG. 8A is a schematic diagram of a terminal according to an embodiment of the present invention;

FIG. 8B is another schematic diagram of a terminal according to an embodiment of the present invention;

FIG. 9A is a schematic diagram of a first base station according to an embodiment of the present invention;

FIG. 9B is another schematic diagram of a first base station according to an embodiment of the present invention;

FIG. 10A is a schematic diagram of a second base station according to an embodiment of the present invention;

FIG. 10B is another schematic diagram of a second base station according to an embodiment of the present invention;

FIG. 11A is a schematic diagram of an MME according to an embodiment of the present invention; and

FIG. 11B is another schematic diagram of an MME according to an embodiment of the present invention.

### DESCRIPTION OF EMBODIMENTS

To make the objectives, technical solutions, and advantages of the present invention clearer, the following further describes the present invention in detail with reference to the accompanying drawings. Apparently, the described embodiments are merely a part rather than all of the embodiments of the present invention. All other embodiments obtained by a person of ordinary skill in the art based on the embodiments of the present invention without undue experiment shall fall within the protection scope of the present invention.

“Multiple” means two or more. The term “and/or” describes an association relationship for describing associated objects and represents that three relationships may exist. For example, A and/or B may represent the following three cases: A exists, both A and B exist, or B exists. The character “/” generally indicates an “or” relationship between the associated objects.

In the following, preferred implementations of the present invention are described in detail with reference to the accompanying drawings. It should be understood that the preferred embodiments described herein are merely used to illustrate and explain the present invention, but are not intended to limit the present invention. In addition, the embodiments of the present application and features in the embodiments may be mutually combined when they do not conflict with each other.

The following describes the embodiments of the present invention in detail with reference to accompanying drawings.

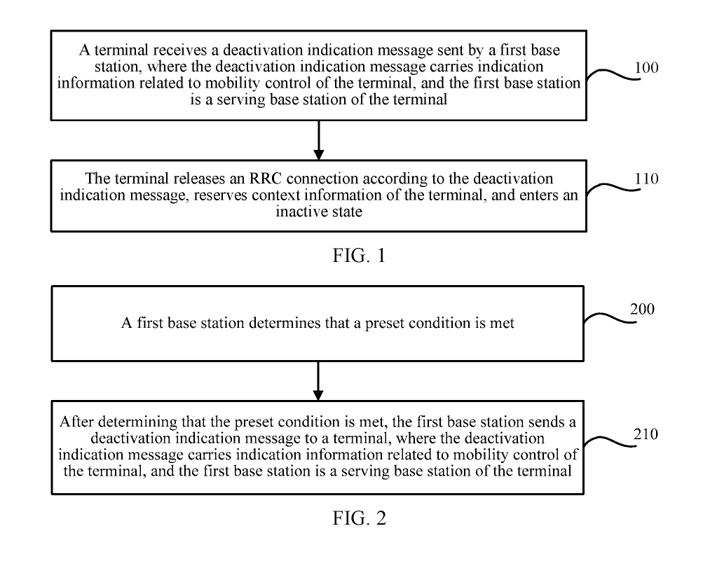

Referring to FIG. 1, in an embodiment of the present invention, a procedure of releasing an RRC connection is as follows:

Step 100: A terminal receives a deactivation indication message sent by a first base station, where the deactivation indication message carries indication information relating to mobility control of the terminal, and the first base station is a serving base station of the terminal.

Step 110: The terminal releases an RRC connection according to the deactivation indication message, reserves context information of the terminal, and enters an inactive state.

It should be noted that, that the terminal is in a connected state is used as a premise in the procedure shown in FIG. 1. Therefore, step 100 may also be described in the following form:

A terminal in a connected state receives a deactivation indication message sent by a first base station, where the deactivation indication message carries indication information relating to mobility control of the terminal, and the first base station is a serving base station of the terminal.

In this embodiment of the present invention, the deactivation indication message may be a message in a new format. When receiving the deactivation indication message, the terminal may determine, according to this new format, to enter the inactive state. Certainly, an original message format may alternatively be used. In this case, the terminal may identify, according to a special identifier in the deactivation indication message, that the terminal is instructed to enter the inactive state.

In this embodiment of the present invention, a condition of triggering the first base station to send the deactivation indication message may be that the terminal requests the first base station to send the deactivation indication message, or may be that the first base station determines by itself, and then sends the deactivation indication message. Therefore, further, in some embodiments, before the receiving, by a terminal, a deactivation indication message sent by a first base station, the method further includes the following operation:
sending, by the terminal, a deactivation request message to the first base station, where the deactivation request message is used to request the first base station to deactivate the terminal.

When the terminal sends the deactivation request message to the first base station, in some embodiments, the terminal identifies that data packets are discontinuously transmitted. In this case, the terminal may send the deactivation request message to the first base station.

In this embodiment of the present invention, in some embodiments, the indication information is used to instruct the terminal in the inactive state to give priority to, when performing cell reselection, a cell controlled by the first base station.

In this case, further, after the entering, by the terminal, an inactive state, the method further includes the following operation:
during cell reselection of the terminal, when determining, according to the indication information, that a first target cell meeting a reselection condition exists in the cell controlled by the first base station, performing cell reselection to the first target cell.

The foregoing describes a case in which the first target cell meeting the reselection condition exists in the cell controlled by the first base station. Certainly, in actual application, there may be a case in which the first target cell meeting the reselection condition does not exist in the cell controlled by the first base station. Therefore, further, after the entering, by the terminal, an inactive state, the method further includes the following operation:
during cell reselection of the terminal, when determining, according to the indication information, that the first target cell meeting the reselection condition does not exist in the cell controlled by the first base station, performing cell reselection according to broadcast cell reselection priority information.

For example, there are a total of three base stations: a base station 1, a base station 2, and a base station 3. The base station 1 is a serving base station of the terminal, and each base station serves four cells. When the terminal needs to perform cell reselection, the terminal first check, according to indication information, whether a first target cell meeting a reselection condition exists in three cells of the base station 1. If yes, the terminal performs cell reselection to the first target cell selected from the cells of the base station 1. Otherwise, the terminal selects the first target cell from 11 cells according to broadcast cell reselection priority information, and then performs reselection to the first target cell; or excludes four cells of the base station 1 and selects the first target cell from cells (eight cells) of the base station 2 and the base station 3.

The cell of the first base station is preferred mainly because the first base station stores the context information of the terminal. When the terminal is activated, the first base station does not need to obtain the context information of the terminal from another base station. Therefore, an activation time delay is reduced, and the activation efficiency is increased.

In the foregoing description, during the cell reselection, the terminal gives priority to the cell of the first base station. In some embodiments, the indication information indicates a cell or base station that is preferred when the terminal in the inactive state performs cell reselection. The preferred cell or base station described herein may be one cell or one base station; or may be multiple cells, where when there are multiple cells, the multiple cells may form a cell list; or may be multiple base stations, where when there are multiple base stations, the multiple base stations may form a base station list.

After the entering, by the terminal, an inactive state, the method further includes the following operation:
during cell reselection of the terminal, when determining, according to the indication information, that a second target cell meeting a reselection condition exists in the preferred cell or a cell controlled by the preferred base station, performing cell reselection to the second target cell.

Further, after the entering, by the terminal, an inactive state, the method further includes the following operation:
during cell reselection of the terminal, when determining, according to the indication information, that the second target cell meeting the reselection condition does not exist in the preferred cell or the cell controlled by the preferred base station, performing cell reselection according to broadcast cell reselection priority information.

For example, there are three preferred base stations: a base station 1, a base station 2, and a base station 3. Each base station serves four cells. When the terminal needs to perform cell reselection, the terminal first check, according to indication information, whether a second target cell meeting a reselection condition exists in 12 cells of the three base stations. If yes, the terminal accesses the second target cell selected from the cells of the three base stations. Otherwise, the terminal selects the second target cell according to broadcast cell reselection priority information, and then performs reselection to the second target cell.

The preferred cell or base station extracts the stored context information of the terminal. In this way, when the terminal is activated, the preferred cell or base station does not need to obtain the context information of the terminal from the first base station. Therefore, an activation time delay is reduced, and the activation efficiency is increased.

In this embodiment of the present invention, in some embodiments, the indication information is used to instruct to notify, when the terminal performs reselection to a cell controlled by a second base station, the second base station that the terminal performs reselection to the cell controlled by the second base station. In this way, the second base station can obtain the context information of the terminal from the first base station in advance, so that a procedure of activating the terminal is faster when the terminal needs to perform data transmission, reducing a data transmission time delay; in addition, accurate paging can be implemented, saving limited paging resources, and reducing a probability of paging congestion.

In this case, after the entering, by the terminal, an inactive state, the method further includes the following operation:
when performing cell reselection to the cell controlled by the second base station, notifying, by the terminal according to the indication information, the second base station that the terminal performs reselection to the cell controlled by the second base station.

In this embodiment of the present invention, further, when the terminal has performed reselection to the cell controlled by the second base station, the second base station needs to send a base station change response message to the terminal, to indicate that the terminal has successfully performed reselection to the cell controlled by the second base station.

In this embodiment of the present invention, the indication information is used to instruct to notify, when the terminal performs reselection to the cell controlled by the second base station, the second base station that the terminal performs reselection to the cell controlled by the second base station. The first base station may configure, according to factors such as a time delay of the terminal, QoS (Quality of Service, quality of service), and whether paging resources are congested, the indication information to achieve the foregoing function.

In this embodiment of the present invention, in some embodiments, to reduce signaling overheads, and prevent a waste of resources, when the terminal notifies, according to the indication information, the second base station that the terminal performs reselection to the cell controlled by the second base station, the terminal may in some embodiments use the following manner:
notifying, by the terminal according to the indication information by using a random access process, the second base station that the terminal performs reselection to the cell controlled by the second base station.

In this embodiment of the present invention, the terminal may establish random access in the following manner:
sending, by the terminal, an RA (Random Access, random access) preamble to the second base station, and sending, by the second base station, an RA response to the terminal after receiving the RA preamble.

Further, when notifying the second base station that the terminal performs reselection to the cell controlled by the second base station, the terminal further informs the second base station of source cell information and terminal identifier information identifying an identity of the terminal.

It should be noted that, after performing the random access process, the terminal does not need to establish an RRC connection. Therefore, the foregoing notifying, by the terminal by using a random access process, the second base station that the terminal performs reselection to the cell controlled by the second base station means that the terminal notifies, by directly using the random access process, the second base station that the terminal performs reselection to the cell controlled by the second base station without needing to establish the RRC connection to notify the second base station that the terminal performs reselection to the cell controlled by the second base station. The terminal may avoid establishing the RRC connection, and therefore the activation efficiency can be increased.

In this embodiment of the present invention, in some embodiments, the source cell information includes an ECGI (Evolved Cell Global Identifier, evolved cell global identifier) or a frequency+PCI (Physical cell Identifier, physical cell identifier).

In this embodiment of the present invention, in some embodiments, the indication information indicates that, after the terminal performs reselection to a cell controlled by a second base station, the terminal is allowed to initiate an activation process at the second base station. In this way, when performing reselection to the second base station, the terminal may initiate the activation process at the cell of the second base station, reducing a data transmission time delay.

Further, after the entering, by the terminal, an inactive state, the method further includes the following operation:
after the terminal performs cell reselection to the cell controlled by the second base station, when determining that a preset condition is met, sending, by the terminal, an activation request message to the second base station, where the activation request message carries source cell information and terminal identifier information identifying an identity of the terminal;
receiving, by the terminal, an activation message sent by the second base station, and recovering a context according to the activation message; and
sending, by the terminal, an activation complete message to the second base station, and entering a connected state.

In the foregoing description, the terminal performs reselection to a cell of the second base station. Certainly, in actual application, the terminal may alternatively perform reselection to a cell of the first base station. Therefore, in this embodiment of the present invention, after the entering, by the terminal, an inactive state, the method further includes the following operations:
when the terminal determines that a preset condition is met, sending, by the terminal, an activation request message to the first base station, where the activation request message carries source cell information and terminal identifier information identifying an identity of the terminal;
receiving, by the terminal, an activation message sent by the first base station, and recovering a context according to the activation message; and
sending, by the terminal, an activation complete message to the source base station, and entering a connected state.

That is, when the terminal performs reselection to the cell of the first base station, the terminal sends the activation request message to the first base station when needing to be activated; and when the terminal performs reselection to the cell of the second base station, the terminal sends the activation request message to the second base station when needing to be activated.

When the terminal determines that the preset condition is met, in some embodiments, the following manners may be used:
the terminal determines that a paging message is received; or
the terminal determines that uplink data arrives; or
the terminal needs to perform a TAU (Tracking Area Update, tracking area update).

In this embodiment of the present invention, after the terminal sends the activation request message to the first base station, the terminal may not receive the activation message sent by the first base station, but receive an activation rejection message sent by the first base station. In this case, the terminal needs to delete the reserved context information, and initiate a process of establishing a new RRC connection.

In this embodiment of the present invention, after recovering the context, the terminal needs to update the recovered context in some cases. Therefore, in this embodiment of the present invention, the activation message carries a context update parameter.

In this case, after the recovering, by the terminal, a context according to the activation message, the method further includes the following operation:
updating, by the terminal, the recovered context according to the context update parameter.

To enhance security, after performing cell reselection, the terminal needs to interact with a base station based on a new key. Therefore, in this embodiment of the present invention, after the receiving, by the terminal, an activation message sent by the first base station or the second base station, the method further includes the following operations:
deriving, by the terminal, a first key or a second key based on information about a cell that initiates activation and the context information reserved by the terminal; and
communicating, by the terminal, with the first base station based on the first key, or communicating with the second base station based on the second key.

To prevent resource occupation caused by hanging of the context information of the terminal, and to increase resource utilization of the terminal, further, the deactivation indication message further carries context validity period information of the terminal.

After the entering, by the terminal, an inactive state, the method further includes the following operation:
starting, by the terminal, a context validity period timer when the terminal enters the inactive state, and if the context validity period timer times out, releasing the context information of the terminal.

In this solution, when releasing an RRC connection, the terminal does not need to release the context information of the terminal. In this way, when entering the connected state again, the terminal does not need to obtain the context information again. Therefore, the signaling overheads are reduced. In this embodiment of the present invention, after the terminal enters the inactive state, a C-RNTI (Cell Radio Network Temporary Identifier, cell radio network temporary identifier) of the terminal is released, and the base station may allocate the C-RNTI to another terminal for use. After the terminal is activated, the base station allocates a new C-RNTI to the terminal for use.

After the terminal enters the inactive state, measurement configurations are reserved. However, in the inactive state, the terminal does not use these measurement configurations to perform measurement of the inactive state, but performs measurement by using a cell reselection parameter broadcast in system information. When being activated, the terminal continues to use the measurement configurations to perform measurement.

In this embodiment of the present invention, in some embodiments, the context information of the terminal may include an RRC configuration, a bearer configuration, security context information, and the like.

In this embodiment of the present invention, in some embodiments, the terminal identifier information includes a C-RNTI and a short MAC (Media Access Control, Media Access Control)-I.

In this embodiment of the present invention, after receiving the deactivation indication message, the first base station also needs to start a context validity period timer, and release the context information of the terminal when the context validity period timer times out.

All the content described above is performed based on that the deactivation indication message carries the indication information. Certainly, in actual application, content indicated by the indication information may alternatively be stipulated in a protocol. In this case, when the terminal receives the deactivation indication message, the terminal performs the content according to the stipulation in the protocol. For example, the protocol stipulates that after the terminal enters the active state, the terminal gives priority to a cell of a serving base station when performing reselection. Therefore, this embodiment of the present invention further includes the following method:
receiving, by a terminal, a deactivation indication message sent by a first base station, where the first base station is a serving base station of the terminal; and
releasing, by the terminal, an RRC connection according to the deactivation indication message, reserving context information of the terminal, and entering an inactive state.

During cell reselection of the terminal, the terminal determines whether a first target cell meeting a reselection condition exists in a cell controlled by the first base station. If yes, the terminal performs the cell reselection to the first target cell. Otherwise, the terminal performs the cell reselection according to broadcast cell reselection priority information.

In the foregoing description, the protocol stipulates that after the terminal enters the active state, when performing reselection, the terminal gives priority to the cell of the serving base station. Certainly, the protocol may alternatively stipulate that, when the terminal performs reselection to the cell controlled by the second base station, the terminal needs to notify the second base station of the information. Therefore, this embodiment of the present invention further includes the following method:
receiving, by a terminal, a deactivation indication message sent by a first base station, where the first base station is a serving base station of the terminal; and
releasing, by the terminal, an RRC connection according to the deactivation indication message, reserving context information of the terminal, and entering an inactive state.

When performing cell reselection to the cell controlled by the second base station, the terminal notifies the second base station that the terminal performs reselection to the cell controlled by the second base station.

Alternatively, the protocol may stipulate that when a preset condition is met, the terminal sends an activation request message to a serving base station of the terminal. Therefore, this embodiment of the present invention further includes the following method:
receiving, by a terminal, a deactivation indication message sent by a first base station, where the first base station is a serving base station of the terminal;
releasing, by the terminal, an RRC connection according to the deactivation indication message, reserving context information of the terminal, and entering an inactive state;
when the terminal determines that a preset condition is met, sending, by the terminal, an activation request message to the first base station, where the activation request message carries source cell information and terminal identifier information identifying an identity of the terminal;
receiving, by the terminal, an activation message sent by the first base station, and recovering a context according to the activation message; and
sending, by the terminal, an activation complete message to the source base station, and entering a connected state.

In some embodiments, that the terminal determines that a preset condition is met includes the following manner:
the terminal determines that a paging message is received; or
the terminal determines that uplink data arrives; or
the terminal needs to perform a TAU.

Referring to FIG. 2, in an embodiment of the present invention, a procedure of releasing an RRC connection is as follows:

Step 200: A first base station determines that a preset condition is met.

Step 210: After determining that the preset condition is met, the first base station sends a deactivation indication message to a terminal, where the deactivation indication message carries indication information relating to mobility control of the terminal, and the first base station is a serving base station of the terminal.

It should be noted that, the terminal in step 210 is a terminal in a connected state.

In this embodiment of the present invention, the deactivation indication message may be a message in a new format. When receiving the deactivation indication message, the terminal may determine, according to this new format, to enter the inactive state. Certainly, an original message format may alternatively be used. In this case, the terminal may identify, according to a special identifier in the deactivation indication message, that the terminal is instructed to enter the inactive state.

In this embodiment of the present invention, when the first base station determines that the preset condition is met, in some embodiments, the following manner may be used:
determining, by the first base station, that an inactivity timer times out; or
receiving, by the first base station, a deactivation request message sent by the terminal, where the deactivation request message is used to request the first base station to deactivate the terminal.

That is, that are two conditions for triggering the first base station to send the deactivation indication message to the terminal, one is that the first base station determines that the inactivity timer times out, and the other is that the first base station receives the deactivation request message sent by the terminal. Certainly, there may further have another trigger condition. This is not specifically limited herein.

In this embodiment of the present invention, in some embodiments, the indication information is used to instruct the terminal in the inactive state to give priority to, when performing cell reselection, a cell controlled by the first base station; or
the indication information indicates a cell or base station that is preferred when the terminal in the inactive state performs cell reselection.

In this embodiment of the present invention, in some embodiments, the indication information is used to instruct to notify, when the terminal performs reselection to the cell controlled by the second base station, the second base station that the terminal performs reselection to the cell controlled by the second base station, and/or, the indication information indicates that, after the terminal performs reselection to the second base station, the terminal is allowed to initiate an activation process at the second base station; and
after the sending, by the first base station, a deactivation indication message to a terminal, the method further includes the following operations:
receiving, by the first base station, a context request sent by the second base station, where the context request carries source cell information, terminal identifier information identifying an identity of the terminal, and target cell information; and
sending, by the first base station, the reserved context information of the terminal to the second base station according to the context request.

In this embodiment of the present invention, in some embodiments, the source cell information includes an ECGI and a frequency+PCI.

It should be noted that, the source cell is a serving cell at which the terminal is located when the terminal receives the deactivation indication message, or may be a camping-on cell or a serving cell at which the terminal is located when the last time the terminal notifies another base station that reselection is performed to a cell controlled by the another base station. A target cell is a camping-on cell or a serving cell when the terminal initiates an activation process, or is a camping-on cell or a serving cell when the terminal notifies the second base station that the terminal performs reselection to the cell controlled by the second base station.

In this embodiment of the present invention, the first base station may configure, according to factors such as a time delay of the terminal, QoS, and whether paging resources are congested, the indication information to be used to instruct to notify, when the terminal performs reselection to the cell controlled by the second base station, the second base station that the terminal performs reselection to the cell controlled by the second base station.

To enhance security, in this embodiment of the present invention, after the receiving, by the first base station, a context request sent by the second base station, the method further includes the following operation:
generating, by the first base station, a first key based on the target cell information, and sending the first key to the second base station.

To increase resource utilization, in this embodiment of the present invention, further, after the sending, by the first base station, the context information of the terminal to the second base station, the method further includes the following operation:
receiving, by the first base station, a context information release message sent by an MME or the second base station, and releasing the reserved context information according to the context information release message.

The foregoing describes a case in which the terminal performs reselection to a cell of the second base station. In actual application, the terminal may alternatively perform reselection to a cell of the first base station. Therefore, in this embodiment of the present invention, after the sending, by the first base station, a deactivation indication message to a terminal, the method further includes the following operations:
receiving, by the first base station, an activation request message sent by the terminal, where the activation request message carries source cell information and terminal identifier information identifying an identity of the terminal;
when determining, according to the source cell information, that a source cell is a cell of the first base station, obtaining, by the first base station, the context information of the terminal;
sending, by the first base station, an activation message to the terminal; and
receiving, by the first base station, an activation complete message sent by the terminal.

In this embodiment of the present invention, in some embodiments, the activation message carries a context update parameter.

In this way, when receiving the activation message, the terminal may update the obtained context information according to the context update parameter.

In this embodiment of the present invention, further, to enhance security, after the receiving, by the first base station, an activation request message sent by the terminal, the method further includes the following operations:
deriving, by the first base station, a second key based on cell identifier information of a cell at which activation is initiated, and the context information reserved by the terminal; and
communicating, by the first base station, with the terminal based on the second key.

In this embodiment of the present invention, after the receiving, by the first base station, an activation complete message sent by the terminal, the method further includes the following operation:
sending, by the first base station, a notification message to a mobility management entity MME, to notify the MME that the terminal enters a connected state.

In this way, the MME informs an S-GW (Serving Gateway, serving gateway) of information indicating that the terminal enters the connected state. After receiving the notification message, the S-GW determines that the terminal establishes an RRC connection to the base station, so that the S-GW may directly transmit data to the terminal. When the S-GW needs to interact with the terminal, the S-GW does not need to send a paging message, thereby reducing paging resource overheads of an air interface.

Similarly, when the terminal enters the active state, the first base station also needs to tell the MME, and the MME informs the S-GW of information indicating that the terminal enters the active state. In this way, the S-GW cannot directly transmit data to the terminal, and needs to perform paging.

The foregoing describes a process of sending, by the first base station, the activation message to the terminal after receiving the activation request message sent by the terminal. In actual application, after receiving the activation request message sent by the terminal, the first base station may not send the activation message to the terminal.

For example, when the first base station does not find the context information of the terminal or the base station determines not to perform activation, the first base station needs to send an activation rejection message to the terminal.

In some embodiments, the activation rejection message may include an activation rejection reason.

In this embodiment of the present invention, in some embodiments, the context information of the terminal may include an RRC configuration, a bearer configuration, security context information, and the like.

In this embodiment of the present invention, in some embodiments, the terminal identifier information includes a C-RNTI and a short MAC-I.

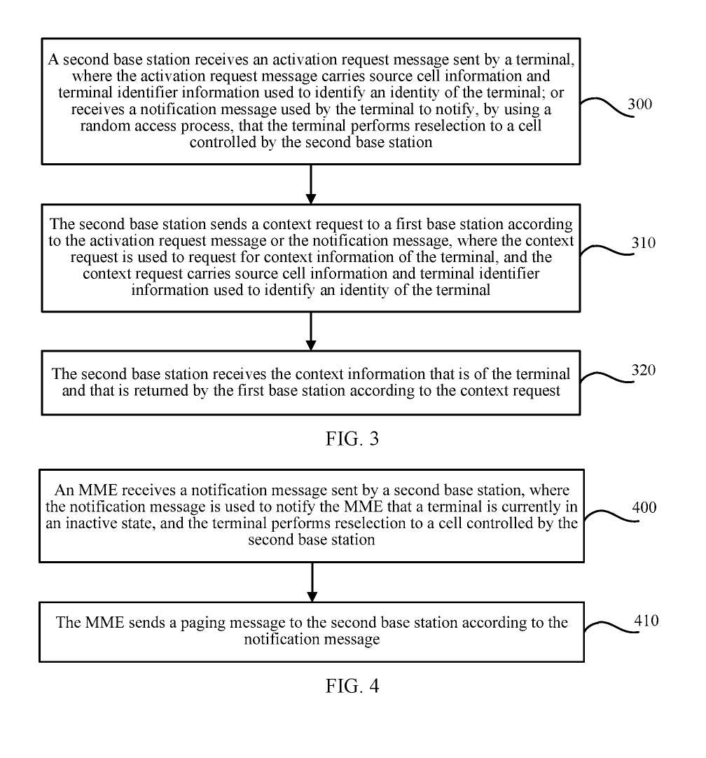

Referring to FIG. 3, in an embodiment of the present invention, a procedure of releasing an RRC connection is as follows:

Step 300: A second base station receives an activation request message sent by a terminal, where the activation request message carries source cell information and terminal identifier information identifying an identity of the terminal; or receives a notification message used by the terminal to notify, by using a random access process, that the terminal performs reselection to a cell controlled by the second base station.

Step 310: The second base station sends a context request to a first base station according to the activation request message or the notification message, where the context request is used to request for context information of the terminal, and the context request carries source cell information and terminal identifier information identifying an identity of the terminal.

Step 320: The second base station receives the context information that is of the terminal and that is returned by the first base station according to the context request.

In this embodiment of the present invention, in some embodiments, the source cell information includes an ECGI and a frequency+PCI.

In this embodiment of the present invention, the second base station receives the activation request message sent by the terminal, where the activation request message carries the source cell information and the terminal identifier information identifying the identity of the terminal; or receives the notification message used by the terminal to notify, by using the random access process, that the terminal performs reselection to the cell controlled by the second base station.

That is, there may be the following two conditions for triggering the second base station to send the context request to the first base station:

One is that the second base station receives the activation request message sent by the terminal. The other is that the second base station determines that the terminal performs reselection to the cell controlled by the second base station.

In this embodiment of the present invention, when the second base station determines that the terminal performs reselection to the cell controlled by the second base station, the second base station needs to send a base station change response message to the terminal, to indicate that the terminal has successfully performed reselection to the cell controlled by the second base station.

In this embodiment of the present invention, further, after the receiving, by a second base station, an activation request message sent by a terminal, and before the sending, by the second base station, a context request to a first base station, the following operation further needs to be performed:
determining, by the second base station according to the source cell information, that a source cell is not a cell controlled by the second base station.

In this embodiment of the present invention, further, after the receiving, by the second base station, the context information that is of the terminal and that is returned by the first base station according to the context request, the method further includes the following operations:
sending, by the second base station, an activation message to the terminal; and
receiving, by the second base station, an activation complete message sent by the terminal, and determining that the terminal enters a connected state.

In this embodiment of the present invention, after determining that the terminal enters the connected state, a second base station further needs to send a path change request message to an MME, and receive a path change response message that is sent by the MME when the MME transfers a data link of an S1 interface of the terminal to the second base station.

In this embodiment of the present invention, to increase resource utilization, after the second base station receives the path change response message that is sent by the MME, the method further includes the following operation:
sending, by the second base station, a context information release message to the first base station.

To enhance security, in this embodiment of the present invention, further, after the sending, by the second base station, a context request to a first base station, the method further includes the following operations:
receiving, by the second base station, a first key sent by the first base station; and
communicating, by the second base station, with the terminal according to the first key.

In this embodiment of the present invention, further, after the receiving, by the second base station, the context information that is of the terminal and that is returned by the first base station according to the context request, the method further includes the following operation:
sending, by the second base station, a notification message to the MME, where the notification message is used to notify the MME of information indicating that the terminal is currently located at the second base station.

In this way, after receiving the notification message, the MME does not deliver a paging message to multiple base stations in a large range any more, but directly sends a paging message to the second base station, thereby reducing paging resource overheads of an air interface.

In this embodiment of the present invention, in some embodiments, the terminal identifier information includes a C-RNTI and a short MAC-I.

Referring to FIG. 4, in an embodiment of the present invention, a procedure of releasing an RRC connection is as follows:

Step 400: An MME receives a notification message sent by a second base station, where the notification message is used to notify the MME that a terminal is currently in an inactive state, and the terminal performs reselection to a cell controlled by the second base station.

Step 410: The MME sends a paging message to the second base station according to the notification message.

In this embodiment of the present invention, when downlink data arrives at the terminal, the MME does not deliver a paging message to multiple base stations according to a TA list, but directly sends a paging message to the second base station, thereby reducing paging resource overheads of an air interface.

In this embodiment of the present invention, to increase resource utilization, after the receiving, by an MME, a notification message sent by a second base station, the method further includes the following operations:
transferring, by the MME, a data link of an S1 interface of the terminal to the second base station; and
sending, by the MME, a context information release message of the terminal to a first base station.

In this embodiment of the present invention, in some embodiments, the MME receives a notification message sent by the first base station, and the notification message is used to notify the MME that the terminal enters a connected state from an active state. In this way, the MME informs an S-GW of information indicating that the terminal enters the connected state, so that the S-GW may directly perform data transmission with the terminal, avoiding sending of a paging message.

To better understand this embodiment of the present invention, the following provides a specific application scenario, to further describe a process of releasing an RRC connection in detail:

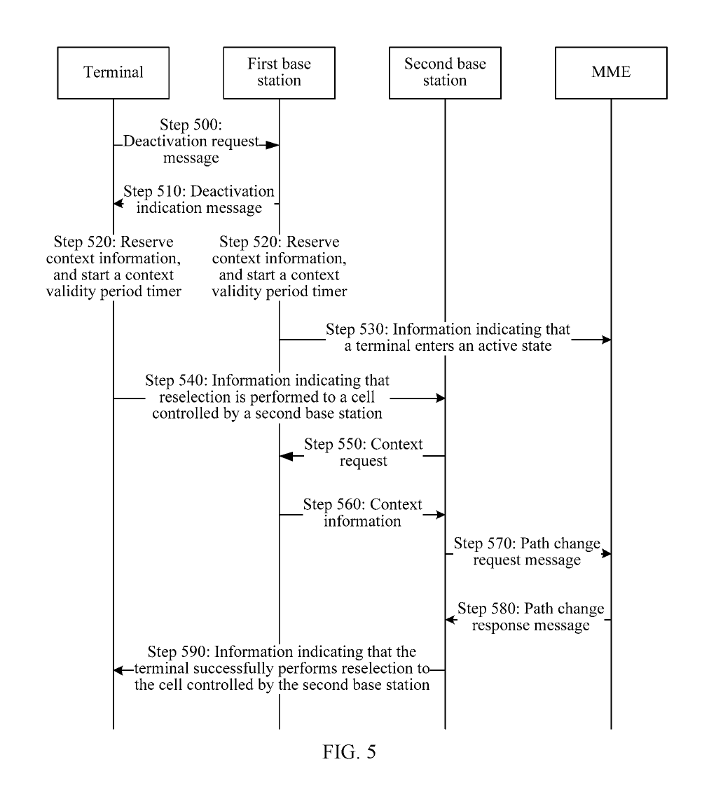

As shown in FIG. 5

### Embodiment 1

Step 500: When determining that data transmission is discontinuous, a terminal sends a deactivation request message to a first base station.

Step 510: The terminal receives a deactivation indication message sent by the first base station, where the deactivation indication message carries indication information relating to mobility control of the terminal, the indication information is used to instruct to notify, when the terminal performs reselection to a cell controlled by a second base station, the second base station that the terminal performs reselection to the cell controlled by the second base station, and the first base station is a serving base station of the terminal.

Step 520: Both the first base station and the terminal reserve context information of the terminal, and start a context validity period timer.

Step 530: The first base station notifies an MME of information indicating that the terminal enters an active state.

Step 540: The terminal notifies, according to the indication information, the second base station of information indicating that the reselection is performed to the cell controlled by the second base station.

Step 550: The second base station sends a context request to the first base station, where the context request carries source cell information, terminal identifier information identifying an identity of the terminal, and target cell information.

Step 560: The first base station obtains the context information of the terminal according to the context request, and sends the context information of the terminal to the second base station.

Step 570: The second base station sends a path change request message to the MME.

Step 580: The second base station receives a path change response message that is sent by the MME when the MME transfers a data link of an S1 interface of the terminal to the second base station.

Step 590: The second base station notifies the terminal of information indicating that the terminal successfully performs reselection to the cell controlled by the second base station.

The embodiment shown in FIG. 5 describes the operations performed when the terminal enters the active state. After the terminal enters the active state, activation needs to be performed again in some cases. Therefore, to describe a process of activating the terminal, the following embodiment is provided:

### Embodiment 2

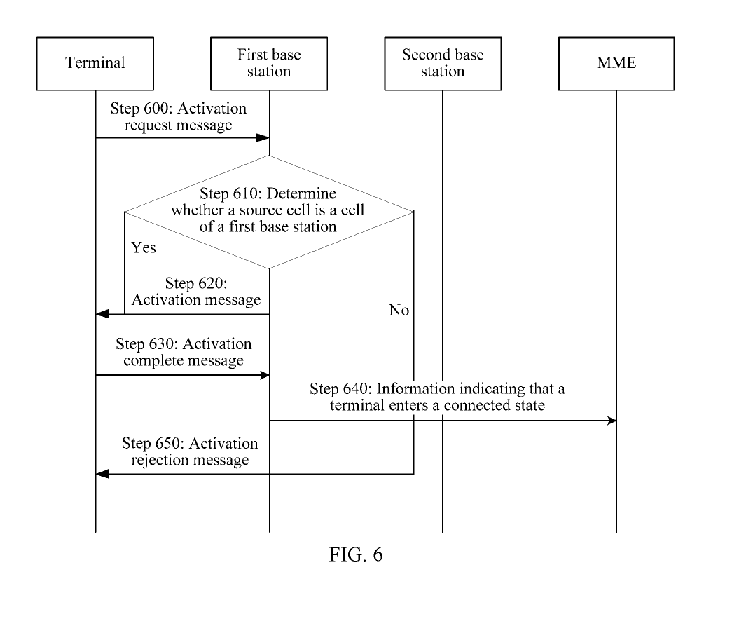

Referring to FIG. 6, this embodiment mainly describes that a terminal is activated at a first base station.

Step 600: When uplink and downlink data arrives at the terminal, the terminal sends an activation request message to the first base station, where the activation request message carries source cell information and terminal identifier information identifying an identity of the terminal.

Step 610: The first base station determines, according to the source cell information, whether a source cell is a cell of the first base station, and if yes, performs step 620; otherwise, performs step 650.

Step 620: The first base station sends an activation message to the terminal.

Step 630: The first base station receives an activation complete message sent by the terminal.

Step 640: The first base station notifies an MME of information indicating that the terminal enters a connected state.

Step 650: The first base station sends an activation rejection message to the terminal.

In some embodiments, the activation rejection message may include an activation rejection reason.

### Embodiment 3

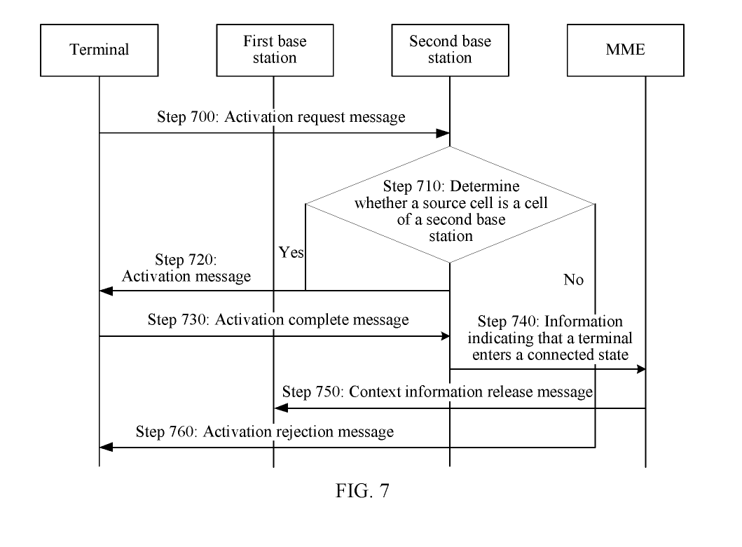

Referring to FIG. 7, this embodiment mainly describes that a terminal is activated at a second base station.

Step 700: When uplink and downlink data arrives at the terminal, the terminal sends an activation request message to the second base station, where the activation request message carries source cell information and terminal identifier information identifying an identity of the terminal.

Step 710: The second base station determines, according to the source cell information, whether a source cell is a cell of the second base station, and if yes, performs step 720; otherwise, performs step 760.

Step 720: The second base station sends an activation message to the terminal.

Step 730: The second base station receives an activation complete message sent by the terminal.

Step 740: The second base station notifies an MME of information indicating that the terminal enters a connected state.

Step 750: The MME sends a context information release message to the first base station, so that the first base station releases reserved context information according to the context information release message.

Step 760: The second base station sends an activation rejection message to the terminal.

In some embodiments, the activation rejection message may include an activation rejection reason.

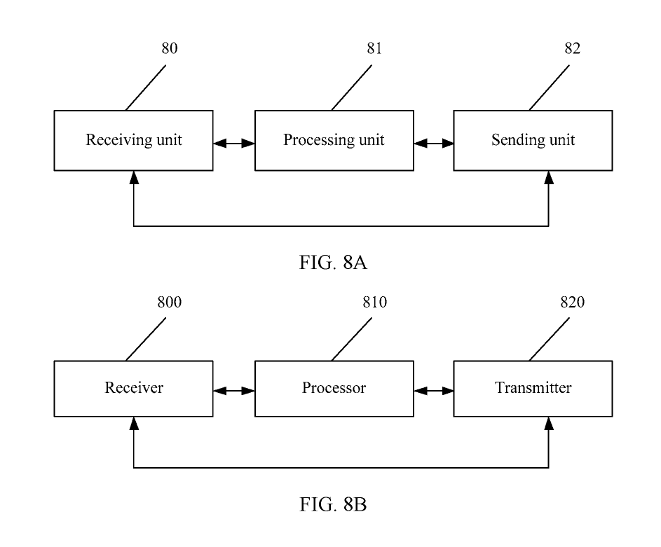

Referring to FIG. 8A, in this embodiment of the present invention, a schematic diagram of a terminal is provided. The terminal includes a receiving unit 80 and a processing unit 81.

The receiving unit 80 receives a deactivation indication message sent by a first base station, where the deactivation indication message carries indication information relating to mobility control of the terminal, and the first base station is a serving base station of the terminal.

The processing unit 81 is configured to: release an RRC connection according to the deactivation indication message received by the receiving unit 80, reserve context information of the terminal, and enter an inactive state.

In this embodiment of the present invention, further, the terminal further includes a sending unit 82, configured to send a deactivation request message to the first base station, where the deactivation request message is used to request the first base station to deactivate the terminal.

In some embodiments, the indication information is used to instruct the terminal in the inactive state to give priority to, when performing cell reselection, a cell controlled by the first base station; and
the processing unit 81 is further configured to: during cell reselection of the terminal, when determining, according to the indication information, that a first target cell meeting a reselection condition exists in the cell controlled by the first base station, perform cell reselection to the first target cell.

Further, the processing unit 81 is further configured to: during cell reselection of the terminal, when determining, according to the indication information, that the first target cell meeting the reselection condition does not exist in the cell controlled by the first base station, perform cell reselection according to broadcast cell reselection priority information.

In some embodiments, the indication information indicates a cell or base station that is preferred when the terminal in the inactive state performs cell reselection; and
the processing unit 81 is further configured to: during cell reselection of the terminal, when determining, according to the indication information, that a second target cell meeting a reselection condition exists in the preferred cell or a cell controlled by the preferred base station, perform cell reselection to the second target cell.

Further, the processing unit 81 is further configured to: during cell reselection of the terminal, when determining, according to the indication information, that the second target cell meeting the reselection condition does not exist in the preferred cell or the cell controlled by the preferred base station, perform cell reselection according to broadcast cell reselection priority information.

In some embodiments, the indication information is used to instruct to notify, when the terminal performs reselection to a cell controlled by a second base station, the second base station that the terminal performs reselection to the cell controlled by the second base station; and
the terminal further includes a sending unit 82, configured to: when the terminal performs cell reselection to the cell controlled by the second base station, notify, according to the indication information, the second base station that the terminal performs reselection to the cell controlled by the second base station.

In some embodiments, that the sending unit 82 notifies, according to the indication information, the second base station that the terminal performs reselection to the cell controlled by the second base station is specifically:
notifying, according to the indication information by using a random access process, the second base station that the terminal performs reselection to the cell controlled by the second base station.

In some embodiments, the indication information indicates that, after the terminal performs reselection to a cell controlled by a second base station, the terminal is allowed to initiate an activation process at the second base station;
the processing unit 81 is further configured to determine that a preset condition is met;
the terminal further includes a sending unit 82, configured to: after the terminal performs cell reselection to the cell controlled by the second base station, when the processing unit 81 determines that the preset condition is met, send an activation request message to the second base station, where the activation request message carries source cell information and terminal identifier information identifying an identity of the terminal;
the receiving unit 80 is further configured to receive an activation message sent by the second base station;
the processing unit 81 is further configured to recover a context according to the activation message; and
the sending unit 82 is further configured to send an activation complete message to the second base station, and enter a connected state.

Further, the processing unit 81 is further configured to determine that a preset condition is met;
the terminal further includes a sending unit 82, configured to: when the processing unit 81 determines that the preset condition is met, send an activation request message to the first base station, where the activation request message carries source cell information and terminal identifier information identifying an identity of the terminal;
the receiving unit 80 is further configured to receive an activation message sent by the first base station;
the processing unit 81 is further configured to recover a context according to the activation message; and
the sending unit 82 is further configured to send an activation complete message to the source base station, and enter a connected state.

In some embodiments, that the processing unit 81 determines that a preset condition is met is specifically:
it is determined that a paging message is received; or
it is determined that uplink data arrives; or
a tracking area update TAU needs to be performed.

In some embodiments, the activation message carries a context update parameter; and
the processing unit 81 is further configured to update the recovered context according to the context update parameter.

Further, the processing unit 81 is further configured to: derive a first key or a second key based on information about a cell that initiates activation and the context information reserved by the terminal; and communicate with the first base station based on the first key, or communicate with the second base station based on the second key.

Further, the deactivation indication message further carries context validity period information of the terminal; and
the processing unit 81 is further configured to: start a context validity period timer, and if the context validity period timer times out, release the context information of the terminal.

Referring to FIG. 8B, in this embodiment of the present invention, a schematic diagram of a terminal is provided. The terminal includes a receiver 800 and a processor 810.

The receiver 800 receives a deactivation indication message sent by a first base station, where the deactivation indication message carries indication information relating to mobility control of the terminal, and the first base station is a serving base station of the terminal.

The processor 810 is configured to: release an RRC connection according to the deactivation indication message received by the receiver 800, reserve context information of the terminal, and enter an inactive state.

It should be noted that, the receiver 800 is further configured to perform another operation performed by the receiving unit 80, and the processor 810 is further configured to perform another operation performed by the processing unit 81. The terminal further includes a transmitter 820, configured to perform an operation performed by the sending unit 82.

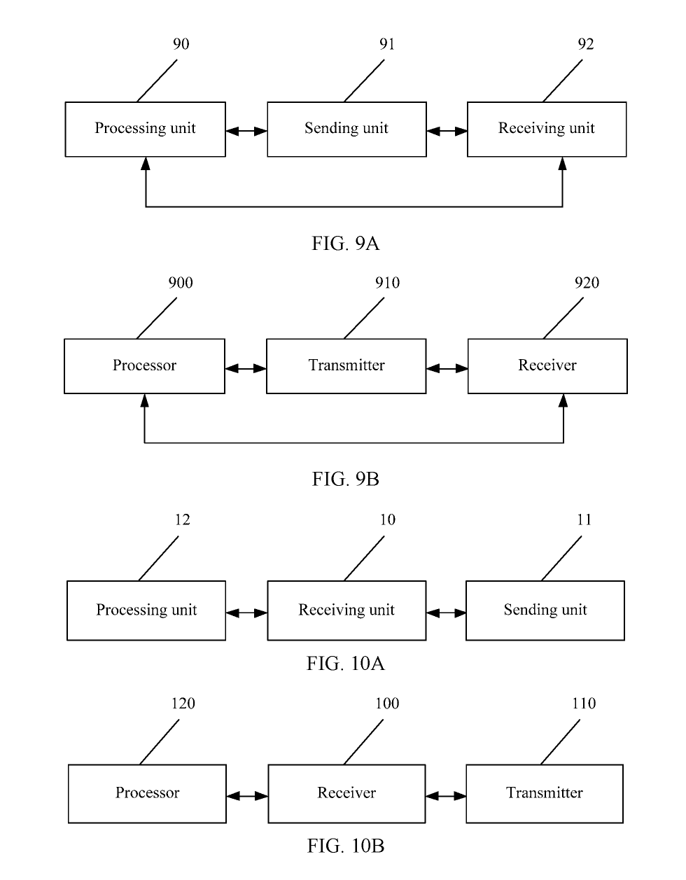

Referring to FIG. 9A, in this embodiment of the present invention, a schematic diagram of a first base station is provided. The first base station includes a processing unit 90 and a sending unit 91.

The processing unit 90 is configured to determine that a preset condition is met.

The sending unit 91 is configured to: after the processing unit 90 determines that the preset condition is met, send a deactivation indication message to a terminal, and reserve context information of the terminal, where the deactivation indication message carries indication information relating to mobility control of the terminal, and the first base station is a serving base station of the terminal.

Further, the first base station further includes a receiving unit 92, configured to receive a deactivation request message sent by the terminal; and
that the processing unit 90 determines that a preset condition is met is specifically:
determining that an inactivity timer times out; or
receiving, by the receiving unit 92, a deactivation request message sent by the terminal, where the deactivation request message is used to request the first base station to deactivate the terminal.

In some embodiments, the indication information is used to instruct the terminal in the inactive state to give priority to, when performing cell reselection, a cell controlled by the first base station; or
the indication information indicates a cell or base station that is preferred when the terminal in the inactive state performs cell reselection.

In some embodiments, the indication information is used to instruct to notify, when the terminal performs reselection to the cell controlled by the second base station, the second base station that the terminal performs reselection to the cell controlled by the second base station, and/or, the indication information indicates that, after the terminal performs reselection to the second base station, the terminal is allowed to initiate an activation process at the second base station; and
the first base station further includes a receiving unit 92, configured to receive a context request sent by the second base station, where the context request carries source cell information, terminal identifier information identifying an identity of the terminal, and target cell information; and
the sending unit 91 is further configured to send the reserved context information of the terminal to the second base station.

Further, the processing unit 90 is further configured to generate a first key based on the target cell information; and
the sending unit 91 is further configured to send the first key to the second base station.

Further, the first base station further includes a receiving unit 92, configured to receive a context information release message sent by an MME or the second base station; and
the processing unit 90 is further configured to release the reserved context information according to the context information release message.

Further, the first base station further includes a receiving unit 92, configured to receive an activation request message sent by the terminal, where the activation request message carries source cell information and terminal identifier information identifying an identity of the terminal;
the processing unit 90 is further configured to: when determining, according to the source cell information, that a source cell is a cell of the first base station, obtain the context information of the terminal;
the sending unit 91 is further configured to send an activation message to the terminal; and
the receiving unit 92 is further configured to receive an activation complete message sent by the terminal.

In some embodiments, the activation message carries a context update parameter.

Further, the processing unit 90 is further configured to: derive a second key based on cell identifier information of a cell at which activation is initiated, and the context information reserved by the terminal; and communicate with the terminal based on the second key.

Further, the sending unit 91 is further configured to send a notification message to a mobility management entity MME, to notify the MME that the terminal enters a connected state.

Referring to FIG. 9B, in this embodiment of the present invention, a schematic diagram of a first base station is provided. The first base station includes a processor 900 and a transmitter 910.

The processor 900 is configured to determine that a preset condition is met.

The transmitter 910 is configured to: after the processor 900 determines that the preset condition is met, send a deactivation indication message to a terminal, and reserve context information of the terminal, where the deactivation indication message carries indication information relating to mobility control of the terminal, and the first base station is a serving base station of the terminal.

It should be noted that, the processor 900 is further configured to perform another operation performed by the processing unit 90, and the transmitter 910 is further configured to perform another operation performed by the sending unit 91. The first base station further includes a receiver 920, configured to perform an operation performed by the receiving unit 92.

Referring to FIG. 10A, in this embodiment of the present invention, a schematic diagram of a second base station is provided. The second base station includes a receiving unit 10 and a sending unit 11.

The receiving unit 10 is configured to receive an activation request message sent by a terminal, where the activation request message carries source cell information and terminal identifier information identifying an identity of the terminal; or receive a notification message used by the terminal to notify, by using a random access process, that the terminal performs reselection to a cell controlled by the second base station.

The sending unit 11 is configured to send a context request to a first base station according to the activation request message or the notification message, where the context request is used to request for context information of the terminal, and the context request carries source cell information and terminal identifier information identifying an identity of the terminal.

The receiving unit 10 is further configured to receive the context information that is of the terminal and that is returned by the first base station according to the context request.

Further, the receiving unit 10 is further configured to receive a first key sent by the first base station; and
the second base station further includes a processing unit 12, configured to communicate with the terminal according to the first key.

Further, the sending unit 11 is further configured to send a notification message to a mobility management entity MME, where the notification message is used to notify the MME of information indicating that the terminal is currently located at the second base station.

Referring to FIG. 10B, in this embodiment of the present invention, a schematic diagram of a second base station is provided. The second base station includes a receiver 100 and a transmitter 110.

The receiver 100 is configured to receive an activation request message sent by a terminal, where the activation request message carries source cell information and terminal identifier information identifying an identity of the terminal; or receive a notification message used by the terminal to notify, by using a random access process, that the terminal performs reselection to a cell controlled by the second base station.

The transmitter 110 is configured to send a context request to a first base station according to the activation request message or the notification message, where the context request is used to request for context information of the terminal, and the context request carries source cell information and terminal identifier information identifying an identity of the terminal.

The receiver 100 is further configured to receive the context information that is of the terminal and that is returned by the first base station according to the context request.

It should be noted that, the receiver 100 is further configured to perform another operation performed by the receiving unit 10, and the transmitter 110 is further configured to perform another operation performed by the sending unit 11. The second base station further includes a processor 120, configured to perform an operation performed by the processing unit 12.

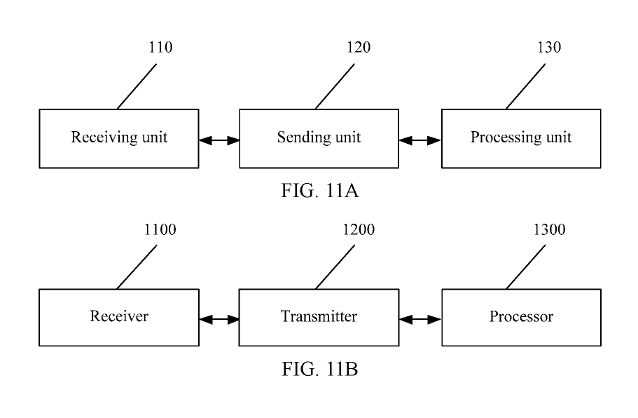

Referring to FIG. 11A, in this embodiment of the present invention, a schematic diagram of an MME is provided. The MME includes a receiving unit 110 and a sending unit 120.

The receiving unit 110 is configured to receive a notification message sent by a second base station, where the notification message is used to notify the MME that a terminal is currently in an inactive state, and the terminal performs reselection to a cell controlled by the second base station.

The sending unit 120 is configured to send a paging message to the second base station according to the notification message.

Further, the MME further includes a processing unit 130, configured to transfer a data link of an S1 interface of the terminal to the second base station; and
the sending unit 120 is further configured to send a context information release message of the terminal to a first base station.

Referring to FIG. 11B, in this embodiment of the present invention, a schematic diagram of an MME is provided. The MME includes a receiver 1100 and a transmitter 1200.

The receiver 1100 is configured to receive a notification message sent by a second base station, where the notification message is used to notify the MME that a terminal is currently in an inactive state, and the terminal performs reselection to a cell controlled by the second base station.

The transmitter 1200 is configured to send a paging message to the second base station according to the notification message.

It should be noted that, the receiver 1100 is further configured to perform another operation performed by the receiving unit 110, and the transmitter 1200 is further configured to perform another operation performed by the sending unit 120. The second base station further includes a processor 1300, configured to perform an operation performed by the processing unit 130.

A person skilled in the art should understand that the embodiments of the present invention may be provided as a method, a system, or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of the present invention have been described, persons skilled in the art can make changes and modifications to these embodiments once they learn the basic inventive concept. Therefore, the following claims are intended to be construed as to cover the preferred embodiments and all changes and modifications falling within the scope of the present invention.

Obviously, persons skilled in the art can make various modifications and variations to the embodiments of the present invention without departing from the spirit and scope of the embodiments of the present invention. The present invention is intended to cover these modifications and variations provided that they fall within the scope of protection defined by the following claims and their equivalent technologies.

What is claimed is:

1. A terminal, comprising:
a receiving unit, configured to receive a deactivation indication message sent by a first base station, wherein the deactivation indication message carries indication information relating to mobility control of the terminal, and the first base station is a serving base station of the terminal; and
a processing unit, configured to: release an Radio Resource Control (RRC) connection according to the deactivation indication message received by the receiving unit, reserve context information of the terminal, and enter an inactive state.

2. The terminal according to claim 1, wherein the processing unit is further configured to determine that a preset condition is met;
the terminal further comprises a sending unit, configured to: when the processing unit determines that the preset condition is met, send an activation request message to the first base station, wherein the activation request message carries terminal identifier information identifying an identity of the terminal;
the receiving unit is further configured to receive an activation message sent by the first base station;
the processing unit is further configured to recover a context according to the activation message; and
the sending unit is further configured to send an activation complete message to the first base station, and enter a connected state.

3. The terminal according to claim 2, wherein the preset condition comprises:
a paging message is received; or
uplink data arrives; or
a tracking area update (TAU) needs to be performed.

4. The terminal according to claim 2, wherein the processing unit is further configured to: derive a key based on information about a cell that initiates activation and the context information reserved by the terminal; and communicate with the base station based on the second key.

5. The terminal according to claim 1, wherein the deactivation indication message further carries context validity period information of the terminal; and
the processing unit is further configured to: start a context validity period timer, and if the context validity period timer times out, release the context information of the terminal.

6. A radio resource control (RRC) connection releasing method, comprising:
sending, by a first base station, a deactivation indication message to a terminal, and
reserving, by the first base station, context information of the terminal, wherein the deactivation indication message carries indication information relating to mobility control of the terminal, and the first base station is a serving base station of the terminal.

7. The method according to claim 6, wherein determining, by the first base station, that a preset condition is met comprises:
determining, by the first base station, that an inactivity timer times out; or
receiving, by the first base station, a deactivation request message sent by the terminal, wherein the deactivation request message is used to request the first base station to deactivate the terminal.

8. The method according to claim 6, wherein
the indication information indicates a cell or base station that is preferred when the terminal in the inactive state performs cell reselection.

9. A first base station, comprising:
a sending unit, configured to: after the processing unit determines that the preset condition is met, send a deactivation indication message to a terminal, and
a processing unit configured to reserve context information of the terminal,
wherein the deactivation indication message carries indication information relating to mobility control of the terminal, and the first base station is a serving base station of the terminal.

10. The first base station according to claim 9, further comprising a receiving unit, configured to receive a deactivation request message sent by the terminal; and
that the processing unit determines that a preset condition is met is specifically:
determining that an inactivity timer times out; or
receiving, by the receiving unit, a deactivation request message sent by the terminal, wherein the deactivation request message is used to request the first base station to deactivate the terminal.

11. The first base station according to claim 9, wherein the indication information indicates a cell or base station that is preferred when the terminal in the inactive state performs cell reselection.
